(19) United States
(12) Patent Application Publication
(10) Pub. No.: US 2007/0263313 A1
(43) Pub. Date: Nov. 15, 2007

(54) Storage apparatus, defect check method, and program

(75) Inventors: Shigeto Kitamura, Kawasaki (JP); Keiichi Sato, Yokohama (JP)

Correspondence Address: Patrick G. Burns, Esq.;Greer, Burns & Crain, Ltd., Suite 2500, 300 South Wacker Dr., Chicago, IL, 60606, US

(73) Assignee: Fujitsu Limited, Kawasaki-shi (JP)

(21) Appl. No.: 11/880,171

(22) Filed: Jul. 20, 2007

Related U.S. Application Data
(63) Continuation of application No. PCT/JP2005/003004, filed on Feb. 24, 2005.

(51) Int. Cl. G11B 19/02; G11B 15/18

(52) U.S. Cl. 360/69

(57) ABSTRACT

A check data write/read unit writes and reads check data of defects in data frame units between servo frames recorded on a medium. A read channel of the check data write/read unit outputs defect detection data in which analog variations due to medium defects such as levels and shifts of a head read signal are determined. A log creation unit creates log information from the defect detection data which is generated through reading of the check data in the data frame units. A defective sector information creation unit creates, through analysis of the log information, and saves a defective sector map indicating positions of defective sectors in a predetermined sector length.

This application is a continuation of PCT/JP2005/003004, filed Feb. 24, 2005.

### TECHNICAL FIELD

The present invention relates to a storage apparatus, a defect check method, and a program which generate defective sector information by checking defects of a medium such as a magnetic disk and, in particular, relates to a storage apparatus, a defect check method, and a program which can create defective sector information supporting sector formats of different sector lengths.

### BACKGROUND ART

Conventionally, in a method which checks defects (defects) of a medium in a storage apparatus such as a hard disk drive, the sector length is fixed to, for example, 512 bytes, and defects of the medium are checked in sector units by using the fixed sector length. In the defect check, check data is written in the fixed sector lengths, then read in the sector units, and stored in a buffer; defect positions are detected in the buffer from patterns that are different from expected values; and byte distances thereof from the index are obtained by calculations and stored in a system area of the medium. Meanwhile, recently, there is a storage apparatus supporting a plurality of sector lengths, wherein for example sector lengths of 512 bytes and 520 bytes are supported. In defect check of such a storage apparatus supporting a plurality of sector lengths, after defect check is performed by using a fixed sector length of for example 512 bytes, the top position of the sectors is shifted so as to perform defect check, thereby checking the gaps between the sectors which are omitted in the first defect check.

FIGS. 1A to 1C show the first defect check using a fixed sector length in the storage apparatus supporting a plurality of sector lengths. In a data frame which is sandwiched between servo gate signals of FIG. 1A, write gate signals of FIG. 1C are output in synchronization with sector pulses of FIG. 1B which are generated based on the fixed sector length, check data is written across the period of the write gate signals, read is performed across the period of read gate signals of FIG. 1C similarly synchronized with the sector pulses same as that of FIG. 1B after the write, it is compared with expected values in the buffer so as to determine defect positions from different patterns. Next, as shown in FIGS. 1D to 1F, the generation positions of sector pulses are shifted with respect to the first time, write gate signals are generated to write check data, read gate signals are generated after the write to perform read, and the part of the gaps between the sectors which are omitted in the first time is subjected to defect check.

Patent Document 1: Japanese Patent Application Laid-Open (kokai) No. 2004-071061

However, the defect check of such a storage apparatus supporting a plurality of sector lengths has following problems. First of all, in an apparatus which supports a plurality of sector lengths although the sector length is not changed after shipment, since defect check has to be performed by the sector length that is used after shipment, the sector length of the apparatus has to be determined before performing the defect check. However, determining a particular sector length among a plurality of sector lengths before shipment from a plant involves a problem that it is hard to make a production plan since sales are expected for each sector length to perform defect check unless it is production of orders from users. Moreover, when the sector length is to be changed for an apparatus that has not satisfied the allowable value of the number of allowable defects in defect check of a particular sector length, defect check has to be performed again by using the sector length after the change, the defect check consumes man-hours, and there is a problem that productivity is reduced. On the other hand, in an apparatus in which the sector length can be changed by a user after shipment, since defects are checked twice by shifting the sector positions as shown in FIGS. 1A to 1F, at least two times that of the apparatus of a fixed sector length is taken as the time required for the defect check, and a serious problem that the number of produced units is reduced by half is caused when the production equipment is same. Moreover, in the conventional defect check, after check data is written to the entire surface of a medium in sector units and read, defects are determined by comparison with expected values in a buffer to determine defect positions, and byte distances from the index to the defect positions are calculated; therefore, there is a problem that time is consumed in the defect check. Furthermore, in the conventional defect check, the check data written to the entire surface of the medium is read, stored in the buffer, and subjected to comparison therein; therefore, there is a problem that the memory capacity of the buffer requires a massive capacity such as 40 GB corresponding to the medium.

### DISCLOSURE OF INVENTION

It is an object of the present invention to provide a storage apparatus, a defect check method, and a program in which defect check supporting a plurality of sector lengths is completed by one time of write and read of check data.

(Apparatus)

The present invention provides a storage apparatus. The storage apparatus of the present invention is characterized by having a check data write/read unit which writes and reads check data of a defect in a data frame unit between servo frames recorded on a medium; a log creation unit which creates log information from defect detection data generated by reading the check data in the data frame unit and saves the log information; and a defective sector information creation unit which creates defective sector information (defective sector map) indicting the position of a defective sector in a predetermined sector length through analysis of the log information and saves the defective sector information.

Herein, in parallel with a write/read process of one track performed by the check data write/read unit, the defective sector information creation unit executes a process of creating the defective sector information from the log information created by the process of one previous track.

The check data write/read unit has a read channel circuit (RDC); the read channel circuit can select and set a first mode in which the check data which is demodulated by subjecting an analog read signal of a head to digital conversion is output, and a second mode in which defect detection data in which analog variation including a level and shift due to a defect of the analog read signal is determined is output; and the second mode is selected and set so as to output the defect detection data.

The check data write/read unit sequentially orders start of write of the check data corresponding to one track at every timing when a first servo gate signal is obtained after on-track to a processing object track is performed, start of read of the check data corresponding to one track, and switch to a next track; the log creation unit creates the log information from the defect detection data read from the track, stores the log information, and stores an index address pointer indicating a log position immediately after an index; and the defective sector information creation unit reads the log information from the log position indicated by the index address pointer and processes the log information.

The log creation unit processes the defect detection data which is output through the medium reading in the data frame unit, and then saves the defect detection data as the log information. The log creation unit compares the defect detection data with mask data which is set in advance and, when the defect detection data is determined as a mask object, eliminates the defect detection data from a log object.

The log creation unit compares the defect detection data with the mask data which is set in advance; and, when the defect detection data is determined as a non-mask object, compares the defect detection data with a defect select value which is determined in advance, and saves the defect detection data as log information when the data includes the defect select value.

When an emerging interval of the defect detection data is equal to or less than a threshold value which is set in advance, the log creation unit extends preceding medium detection data and combines the preceding data with the succeeding medium detection data so as to convert the data into one defect detection data.

The log creation unit stores, as the log information, defect information which is determined for each of the data frame from the defect detection data subsequent to frame start position information. The log creation unit stores, as the defect information, a defect start position, a defect length, and a defect type.

The defective sector information creation unit converts one or plural pieces of defect information included in the log information into a sector number, and, when the total number of a defect in the same sector exceeds ECC correction ability, registers the number in the defective sector information as a defective sector.

The defective sector information creation unit creates the defective sector information from the log information for a plurality of different sector lengths in accordance with needs.

When the total number of defective sectors exceeds a predetermined allowable value according to the defective sector information of the predetermined sector length, the defective sector information creation unit changes the sector length to another predetermined sector length and creates defective sector information again from the log information.

(Method)

The present invention provides a defect check method of a storage apparatus. The defect check method of the present invention is characterized by including

a check data write/read process in which check data of a defect is written and read in a data frame unit between servo frames recorded on a medium;

a log creation process in which log information is created from defect detection data generated by reading the check data in the data frame unit and saved; and

a defective sector information creation process in which defective sector information indicting the position of a defective sector in a predetermined sector length is created through analysis of the log information and saved.

(Program)

The present invention provides a program executed by a processor(computer) of the storage apparatus. The program of the present invention is characterized by causing the processor(computer) of the storage apparatus to execute

a check data write/read process in which check data of a defect is written and read in a data frame unit between servo frames recorded on a medium;

a log creation process in which log information is created from defect detection data generated by reading the check data in the data frame unit and saved; and

a defective sector information creation process in which defective sector information indicting the position of a defective sector in a predetermined sector length is created through analysis of the log information and saved.

Note that, details of the defect check method and the program of the present invention are basically same as the case of the storage apparatus of the present invention.

According to the present invention, when defect check is performed by writing and reading check data in data frame units between servo frames recorded on a medium, even in a storage apparatus supporting a plurality of sector lengths, defects of all the data frames including gapes between sectors can be checked by one time of defect check, the defect check can be completed in the time equivalent to that of an apparatus of a fixed sector length, and the time required for defect check of the apparatus supporting a plurality of sector lengths can be shortened.

Moreover, since defective sector information is created by analyzing the log information of one previous track in parallel with write/read of the check data performed in track units and creation of log information, creation of the defective sector information can be completed approximately at the same time as the creation of the log information performed by writing and reading of the check data with respect to the medium, processing time can be shortened compared with the case in which the defective sector information is created after storing in a buffer, and the buffer capacity required in the process can be also reduced.

Moreover, when the check data is to be read from the medium, as an operation mode of the read channel used in reading, a mode (second mode) in which defect detection data obtained by determining the level variations and level shift due to medium defects of a head read signal is output is set, and the defect detection data in which defects are determined as the check data is acquired so as to create log information; therefore, the process of determining defect positions by comparing, with expected values, the read check data output from the read channel in an operation mode (first mode) in which read check data is demodulated from the head read signal becomes unnecessary, the processing load of the defect check is reduced, and the processing time can be shortened.

Moreover, when the defect detection data output from the read channel is to be registered as the log information, processing such as elimination of unnecessary defect detection data by mask processing, extraction of required defect detection data according to a defect select value, and rounding in which data is integrated into one when the emerging interval of defect detection data is short are performed; thus, the registration capacity of the required log information is reduced, and the load and time of the creation process of the defective sector information through analysis of the log information can be reduced.

Furthermore, when the defective sector information is to be created from the log information, the sector length is changed in the case in which the total number of defective sectors exceeds an allowable amount of the apparatus, and defective sector information can be created by recalculation based on the same log information; and, the log information of the defect detection data is once created, the same log information can be used for the change of the sector length thereafter so as to readily create the defective sector information corresponding to the changed sector length.

### BRIEF DESCRIPTION OF DRAWINGS

FIGS. 1A to 1F are time charts of two times of write/read of check data in a conventional apparatus supporting a plurality of sector lengths;

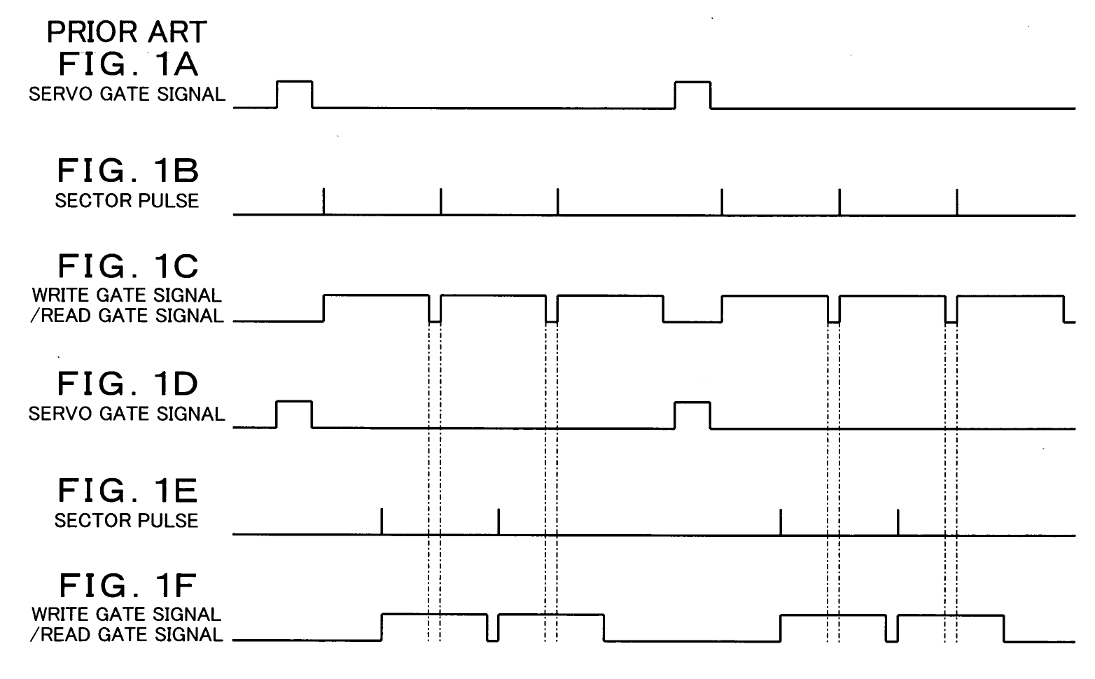

FIGS. 2A and 2B are block diagrams of a functional configuration of a magnetic disk apparatus according to the present invention;

FIG. 3 is an explanatory diagram of servo frames and data frames in a medium track;

FIG. 4 is an explanatory diagram of a check data write process in the apparatus configuration of FIGS. 2A and 2B;

FIGS. 5A to 5D are time charts of the write process of FIG. 4;

FIG. 6 is an explanatory diagram of a check data read process in the apparatus configuration of FIGS. 2A and 2B;

FIGS. 7A to 7E are time charts of the read process of FIG. 6;

FIGS. 8A to 8C are time charts of the process according to the present invention in which track switching and write/read of the check data is performed asynchronous with an index;

FIG. 9 is an explanatory diagram of log information created by the read process of FIGS. 8A to 8C and index address pointers;

FIGS. 10A and 10B are time charts of a defect check process by the configuration of FIGS. 2A and 2B;

FIGS. 11A and 11B are flow charts of the defect check process by the processor of FIGS. 2A and 2B;

FIG. 12 is an explanatory diagram of defect log information saved in the DRAM of FIGS. 2A and 2B;

FIG. 13 is a flow chart of a log registration process by the defect check of FIGS. 2A and 2B;

FIGS. 14A to 14D are explanatory diagrams of the defect detection data, mask data, and a log select value in the log registration process;

FIGS. 15A and 15B are explanatory diagrams of defect detection data subjected to log registration, in which bits of mask data are not set and bits of the log select value are set, and log data;

FIGS. 16A and 16B are explanatory diagrams of defect detection data, which is eliminated from log registration according to the mask data, and log data;

FIGS. 17A and 17B are explanatory diagrams of defect detection data, which is eliminated from log registration since the bits of the log select value are not set, and log data;

FIGS. 18A and 18B are explanatory diagrams of defect detection data, which is rounded into one by extending continuous defect detection data, and log data;

FIGS. 19A and 19B are explanatory diagrams of defect detection data pieces, which are adjacent to each other within the defect length extension count threshold value, and log data;

FIGS. 20A and 20B are explanatory diagrams of defect detection data pieces, which are adjacent to each other with an interval exceeding the defect length extension count threshold value, and log data;

FIGS. 21A and 21B are explanatory diagrams of log registration in the case in which defect detection data in which bits of mask data are set in the continuous defect detection data, is present;

FIGS. 22A and 22B are flow charts of a defective sector map creation process by the processor of FIGS. 2A and 2B; and

FIG. 22C is a flow chart of the defective sector map creation process subsequent to FIGS. 22A and 22B.

### BEST MODE FOR CARRYING OUT THE INVENTION

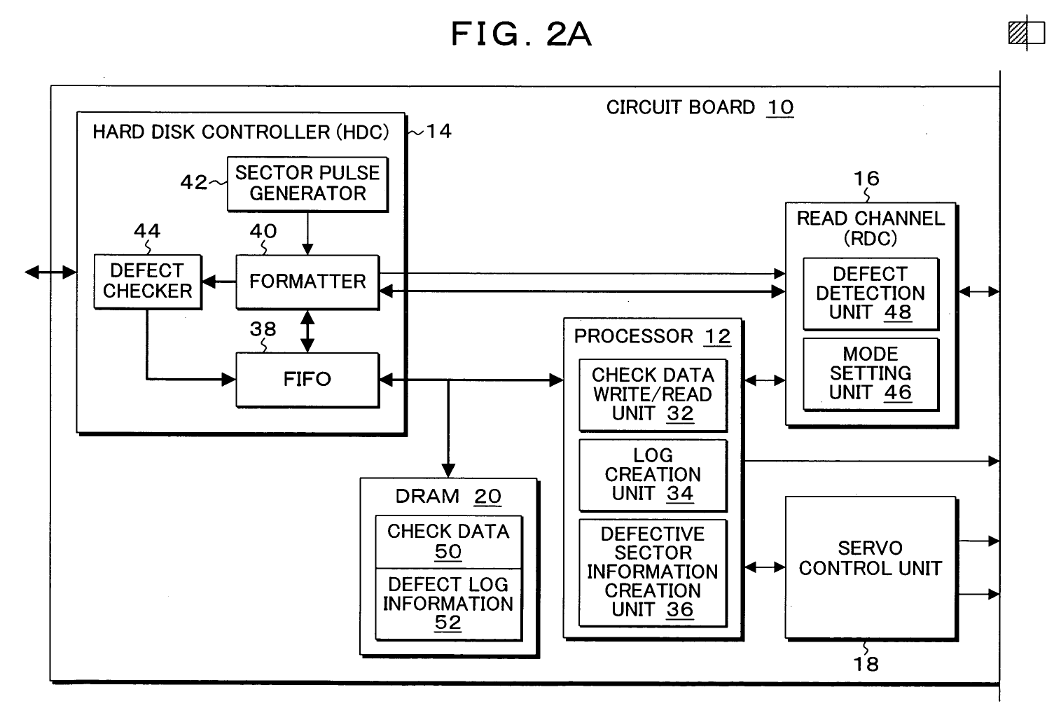

FIGS. 2A and 2B are block diagrams of a magnetic disk apparatus to which a defect check process according to the present invention is applied. In FIGS. 2A and 2B, the magnetic disk apparatus, which is known as a hard disk drive (HDD) is composed of a circuit board 10 and a disk enclosure 11. In the circuit board 10, a processor 12, a hard disk controller (HDC) 14, a read channel (RDC) 16, a servo control unit 18, and a DRAM 20 are provided. In the disk enclosure 11, a read/write amplifier 24, a head assembly 26, a voice coil motor 28, and a spindle motor 30 are provided. One or a plurality of magnetic disk media, which are not shown, are attached to a rotating shaft of the spindle motor 30 and rotated at a constant speed. The head assembly 26 is supported by a distal end of an arm of a head actuator, and, when the head actuator is driven by the voice coil motor 28, the head assembly 26 having a read head and a write head is positioned with respect to the medium surface of the magnetic disk medium. The write head provided in the head assembly 26 is connected to a write amplifier side of the read/write amplifier 24, and the read head is connected to a read amplifier side of the read/write amplifier 24. In addition, ahead select circuit of the heads provided in the head assembly 26 is provided in the read/write amplifier 24, wherein write or read is performed according to a head select signal based on a write command or a read command from the processor 12 so as to select any one of the heads. In the processor 12 provided in the circuit board 10, as functions realized by program execution or firmware, a check data write/read unit 32, a log creation unit 34, and a defective sector information creation unit 36 are provided. As functions corresponding to the functions for a defect check process in the processor 12, a FIFO 38, a formatter 40, a sector pulse generator 42, and a defect checker 44 are provided in the hard disk controller 14. In addition, in the read channel 16, a defect detection unit 48 and a mode setting unit 46 are provided as functions which output defect detection data used in creation of defect log information upon read of check data from the magnetic disk medium in the defect check process of the present invention. Furthermore, corresponding to the defect check process of the present invention, in the DRAM 20, check data 50, which is used in defect check, and defect log information 52, which is created and registered by read of the check data from the magnetic disk medium is stored. Furthermore, a defective sector map created by calculations from the defect log information 52, which is obtained in the defect check process of the present invention, is stored in a system area of an magnetic disk medium (is not illustrated), which is provided in the disk enclosure 11. The circuit board 10 and the disk enclosure 11 perform normal write processes and read processes based on commands from a host. Herein, normal operations in the magnetic disk apparatus will be briefly described below. When a write command and write data from the host are received by a host interface 8is not illustrated) provided in the hard disk controller 14, the write command is decoded by the processor 12; in accordance with needs, including buffering of the DRAM 20 which functions as a transfer buffer, the received write data is converted into a predetermined data format by the formatter 40, which is provided in the hard disk controller 14; an ECC code is added thereto by an ECC processing unit (is not illustrated); scrambling, RLL code conversion, and write compensation are performed in a write system in the read channel 16; and it is then written to the magnetic disk medium from the write head which is selected from the write amplifier via the head assembly 26. In this course, a head positioning signal is given from the processor 12 to the servo control unit 18 using a DSP or the like, and positioning control wherein the head is caused to seek a position ordered by the command and placed on the track is performed by the voice coil motor 28. Meanwhile, in a read operation, a read signal read from a read head of the head assembly 26 which is selected by head selection is amplified by the read amplifier and then input to a read system of the read channel 16, read data is demodulated by partial response maximum likelihood detection (PRML) or the like, ECC processing is performed by the hard disk controller 14 so as to detect and correct errors, buffering to the DRAM 20 serving as a transfer buffer is then performed, and the read data is transferred to the host from the host interface. Next, regarding the magnetic disk apparatus, functions for the defect check process according to the present invention will be described. When the defect check process is started, the check data write/read unit 32 provided in the processor 12 executes a check data write/read process in which, after the check data 50 is deployed on the DRAM 20, the check data is written in the units of data frames between servo frames recorded on the medium with respect to the magnetic disk medium of the disk enclosure 11 side via the hard disk controller 14 and the read channel 16 and then read. The log creation unit 34 of the processor 12 creates log information from the defect detection data which is generated through read of the check data by the check data write/read unit 32 from the magnetic disk medium in the data frame units and registers it in the DRAM 20 as the defect log information 52. In this course, when the check data written to the magnetic disk medium is to be read, in the read channel 16, mode setting in which the function of the defect detection unit 48 is caused to be effective is performed by the mode setting unit 46. In the read channel 16, two operation modes can be selected, wherein, in a first mode, as well as a normal read operation according to a read command from the host, after an analog read signal read from the head of the magnetic disk medium is subjected to AD conversion, read data is demodulated by partial response maximum likelihood detection or the like and output; and, in a second mode, variations due to defects, for example, the level magnitude or level shift of the analog read signal from the head are determined, and defect detection data is output. Therefore, in the present invention, when the defect check process is to be executed by the processor 12, the second mode in which the defect detection data is output as read data with respect to the read channel 16 is set by the mode setting unit 46, and the function of the defect detection unit 48 is caused to be effective. Therefore, regarding the head read signal from the check data written on the magnetic disk medium upon the defect detection process, the defect detection data is output as NRZ data from the read channel 16 if a defect is determined, and the defect detection data is registered in the DRAM 20 as the defect log information 52 under the direction of the log creation unit 34. The defect detection data output from the read channel 16 is transmitted from the formatter 40 of the hard disk controller 14 to the defect checker 44 and stored in the DRAM 20 through the FIFO 38. The defect checker 44 subjects the defect detection data output from the read channel 16 to processing such as elimination from a log object according to mask data, extraction as a log object according to a log select value, and rounding in which the defect detection data is combined into one if it is continuous with predetermined data intervals, and then registers it in the defect log information 52 via the FIFO 38. The defective sector information creation unit 36 analyzes the defect log information 52 registered in the DRAM 20, thereby creating a defective sector map as the defective sector information indicating positions of defective sectors in a particular sector length among a plurality of sector lengths supported by the magnetic disk apparatus of the present invention and saves that in the system area of the magnetic disk medium.

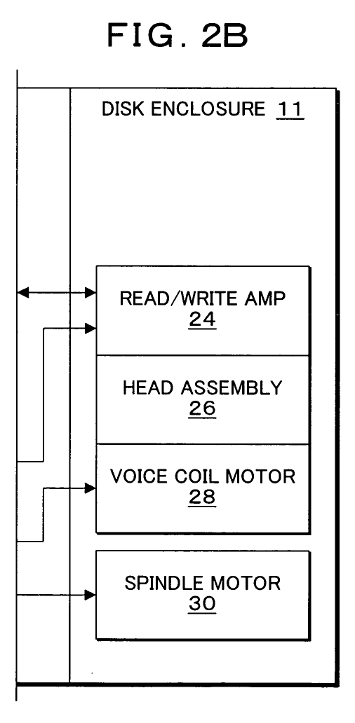

FIG. 3 is an explanatory diagram of servo frames and data frames in a track of the magnetic disk medium provided in the magnetic disk apparatus of FIGS. 2A and 2B. FIG. 3 extracts one track on the magnetic disk medium and shows that on a straight line, wherein an index servo frame 56-1 storing index information is provided at the track top, starting from the index servo frame 56-1, servo frames 56-2, 56-3, 56-n are provided at a constant rotation angle interval, and the number of the servo frames per one track, i.e., per one cycle is 140 to 150 frames. Data frames 58-1 to 58-n are disposed respectively between the plurality of servo frames 56-2 to 56-n, which are subsequent to the index servo frame 56-1 at the top; and, read/write of data is performed after each of the data frames 58-1 to 58-2 is subjected to sector format according to a plurality of sector lengths, for example, the sector length of 512 bytes or 520 bytes.

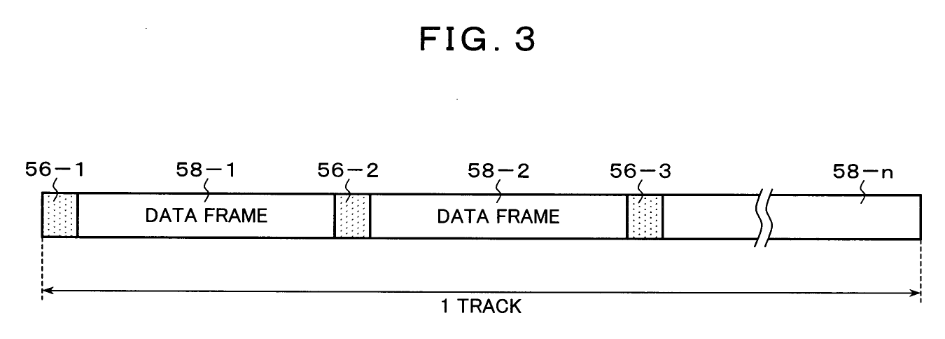

FIG. 4 is an explanatory diagram of a check data write process in the apparatus configuration of FIGS. 2A and 2B, wherein the processor 12, the FIFO 38, the formatter 40, the sector pulse generator 42, and the defect checker 44 in the hard disk controller 14, and the read channel 16 shown FIGS. 2A and 2B are disposed and shown along with the flow of data with respect to the magnetic disk medium 60. In the write process of FIG. 4 of check data, in the first place, the check data 50, which is for defect check, is written and set from the processor 12 to the DRAM 20. As the check data 50, for example, a repeated pattern of “0011” which is a 2T pattern is used, and 8 to 10 bits of the repeated pattern is used as one word to create the check data 50. The check data 50 is written in the units of the data frames 58-1 to 58-n shown in FIG. 3; thus, it has a size of
(check data length)=(frame data length)×(number of frames).

The processor 12 sets the sector pulse generator 42 so that a sector pulse is generated once immediately after a servo gate signal indicating a servo frame. When setting of the sector pulse generator 42 is completed, the processor 12 activates the formatter 40 for writing the check data 50, which is for defect check, to the disk medium 60. The formatter 40 generates a write gate signal WG across the data frame period between the servo sectors in synchronization with the sector pulse and writes the check data to the disk medium 60 via the read channel 16 while the write gate signal is valid. In other words, the write gate signal is generated based on the sector pulse so that the sector length in the write of the check data is the data frame length, and the number of sectors in this case is equal to the number of servo frames per one rotation.

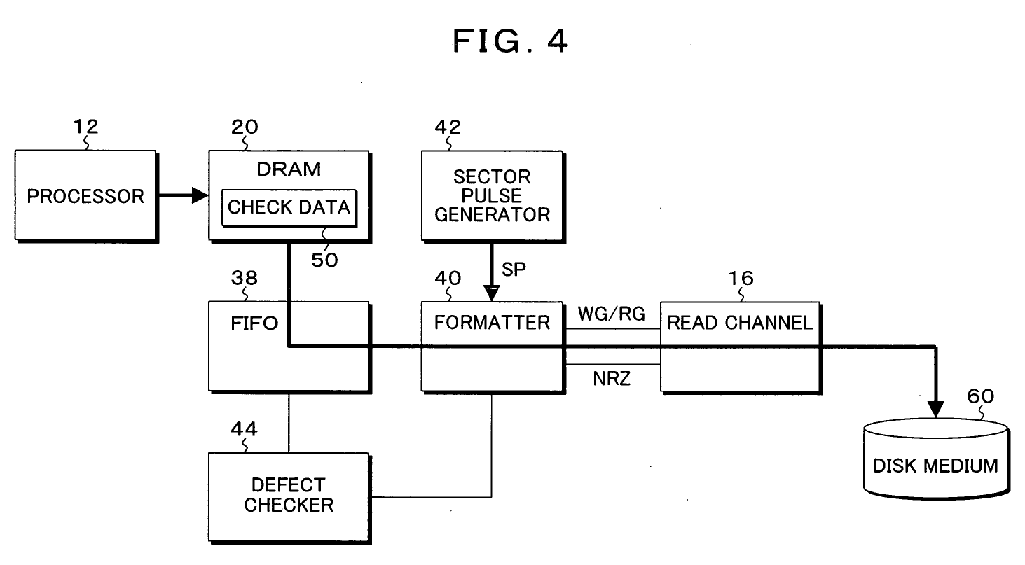

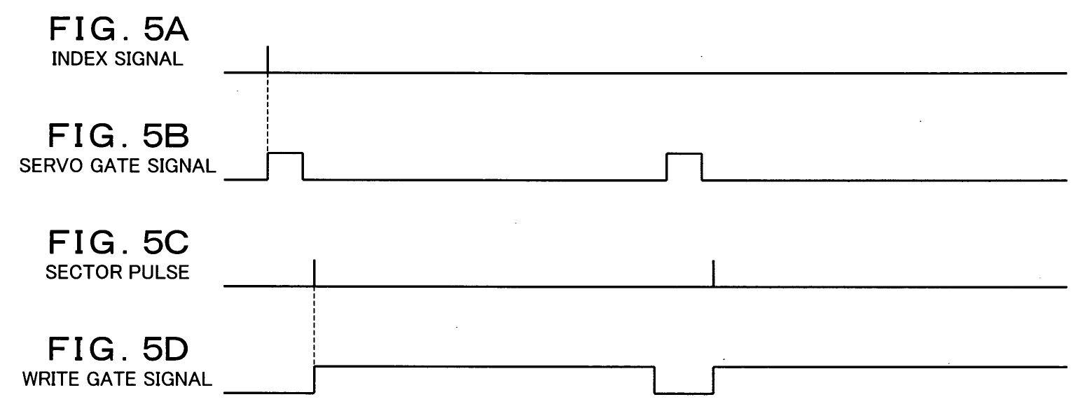

FIGS. 5A to 5D are time charts of an index signal, the servo gate signal, the sector pulse, and the write gate signal in the write process of FIG. 4. The index signal of FIG. 5A is generated when the index servo frame 56-1 shown in FIG. 3 is read, and the servo gate signal of FIG. 5B is generated in synchronization with read of each of the servo frames 56-1 to 56-n of FIG. 3. The sector pulse of FIG. 5C is generated once at the timing immediately after the servo gate between the servo gates. The write gate signal FIG. 5D is generated in synchronization with the sector pulse and is generated at an end position of the data frame determined by the servo gate interval, i.e., immediately before rise of a next servo gate signal. As shown in FIG. 4 and FIGS. 5A to 5D, when write of the defect check data with respect to a certain track is finished, a read process of the check data shown in FIG. 6 is performed. In the read process of check data in FIG. 6, after the sector pulse generator 42 is set so that sector pulses are generated at similar timing as that of the write, the formatter 40 is activated, and the check data, which has already been written, is read from the disk medium 60 via the read channel 16.

As shown in FIGS. 2A and 2B, the read channel 16 causes the defect detection unit 48 to be effective by setting the second mode by the mode setting unit 46; therefore, defect detection data in which defects are determined from analog level magnitudes, shift, etc. of the head read signal is output as NRZ data.

The defect detection data is stored in the FIFO 38 through the formatter 40 and then through the defect checker 44. When a certain amount of the defect detection data is accumulated in the FIFO 38, it is transferred to the DRAM 20 and registered as the defect log information 52. The defect checker 44 subjects the defect detection data, which is obtained via the formatter 40, to processing such as a mask process, an extraction process, rounding based on mask data, a log select value, and a defect length extension count, which are set in advance, and outputs that to the FIFO 38.

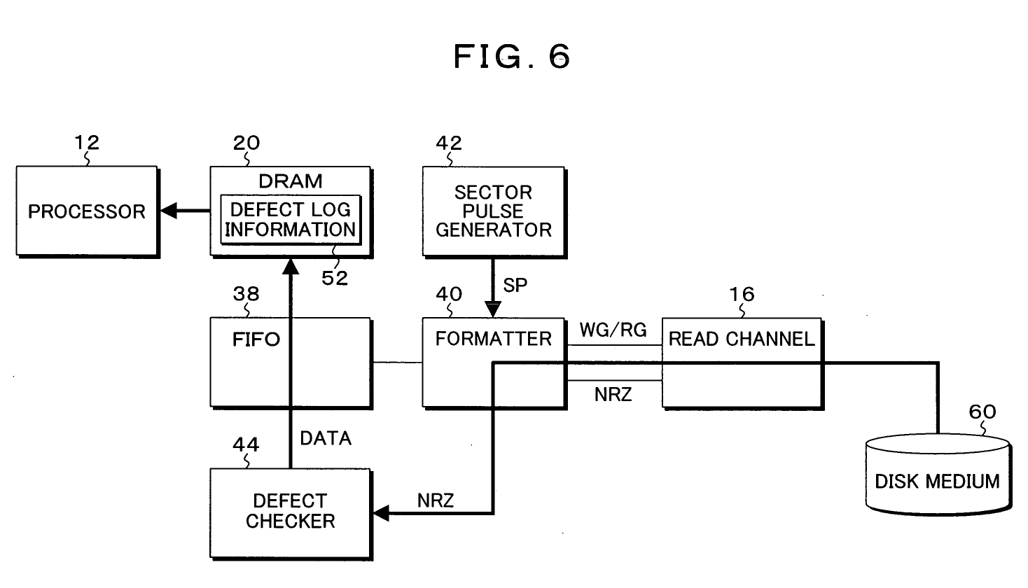

FIGS. 7A to 7E are time charts of the read process of FIG. 6. In FIG. 7A, an index signal is generated when the index servo frame at the top is read, and the servo gate signal is generated at the same time as shown in FIG. 7B, wherein the servo gate signals are generated at an interval of a constant rotation angle. The sector pulse generator 42 of FIG. 6 is set so that the sector pulse of FIG. 7C is generated once immediately after the servo gate, which is same as the write process of FIGS. 5A to 5D, and a read gate signal of FIG. 7D is generated across the data frame in synchronization with the sector pulse. The formatter 40 is activated in synchronization with the sector pulse immediately after the servo gate signal and causes the defect detection data from the read channel 16 based on read from the disk medium 60 to be output across the data frame wherein an input gate signal is validly output. Herein, since an AD converter provided in the read channel 16 generally has predetermined read latency time, the data output from the read channel 16 upon read of FIG. 6 involves delay until the NRZ data serving as the defect detection data becomes valid after the read gate is asserted. Therefore, as shown in the read NRZ data of FIG. 7D, after the read gate is asserted and predetermined read latency time T1 elapses, the read NRZ data is output as valid data to the formatter 40. Also in the case in which the read gate is negated, similarly, the read NRZ data is caused to be invalid from valid after the predetermined read latency time T1, and this is repeated thereafter.

Next, index address pointers used in log creation through reading of the check data of the present invention will be described. When track switching is performed in the process of the defect check of the present invention, and if the formatter 40 is activated from an index, rotation waiting is caused, and check time is increased. Therefore, although write and read is performed for a first track, which is to be processed first, by activating the formatter in synchronization with the index; for a second track and those subsequent to that, write and read is performed by activating the formatter asynchronous with indexes after on-track performed by track switching, thereby eliminating rotation waiting.

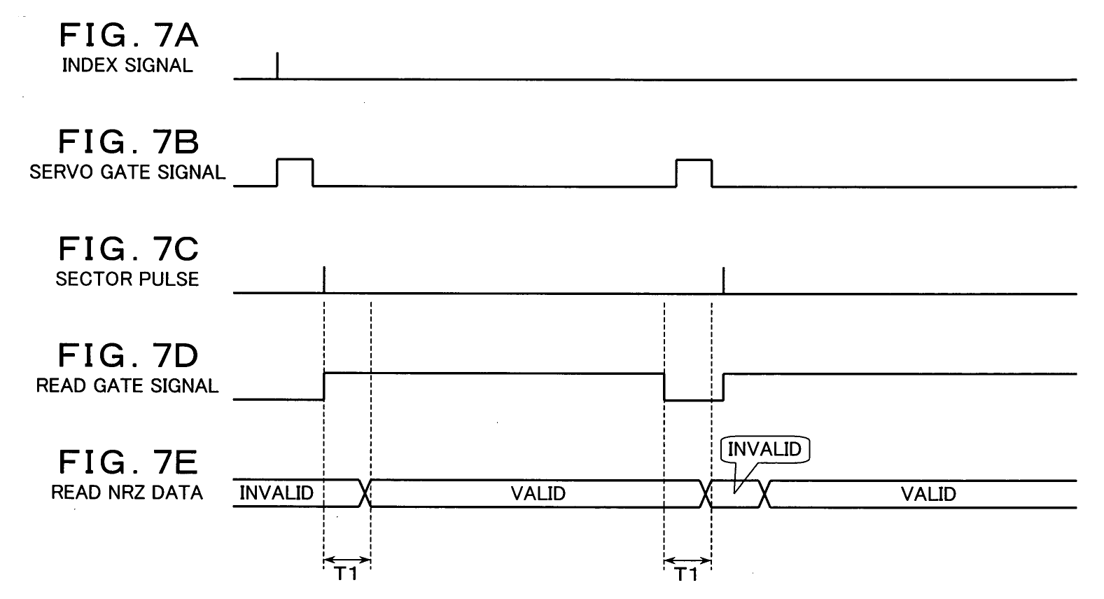

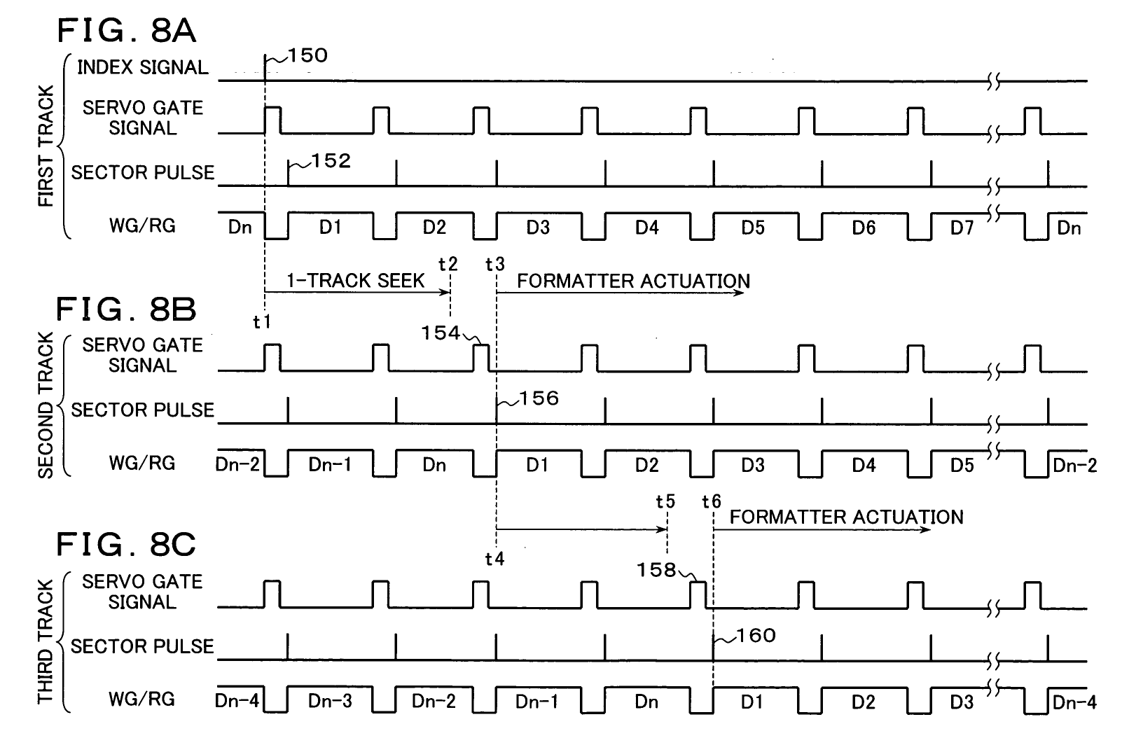

FIG. 8A is a time chart of the first track, which is to be processed first, wherein the formatter is activated in synchronization with a sector pulse 152 based on an index 150, and write and read of the check data according to a write gate signal or a read gate signal is performed. In this case, defect detection data D1 to Dn of the data frames obtained by reading is continuously obtained in the amount corresponding to one track successively from the data frame immediately after the index and successively stored in a log region 64 on the DRAM of FIG. 9, and, at the same time, an index address pointer 65-1 indicating the data position immediately after the index is retained. Subsequently, regarding a second track, as shown in FIG. 8B, when one-track seek is performed in synchronization with the index signal at time t1, and on-track to the second track is performed at time t2 which is after certain skew time, the formatter is activated in synchronization with a sector pulse 156 based on a servo gate signal 154 which is obtained first thereafter, and write and read of the check data according to a write gate signal or a read gate signal is performed. In this case, the defect detection data D1 to Dn of the data frames obtained by reading is successively obtained in the amount corresponding to one track wherein the data frame at a position delayed with respect to the index 150 by the skew time caused by track switching is the top position, it is stored in the order in the log region 64 of FIG. 9, and, at the same time, an index address pointer 65-2 indicating that the data immediately after the index is defect detection data Dn-1 is retained. Also regarding a third track of FIG. 8C, one-track seek is performed at time t4 which is synchronized with the servo gate 154 at which the formatter of the second track is activated, the formatter is activated in synchronization with a sector pulse 160 based on a servo gate signal 158 which is obtained first after time t5 when on-track to the third track is performed after certain skew time, and writ and read of the check data is repeated. In this manner, in the present invention, after the second track, when on-track is performed after track switching, the formatter is activated in synchronization with the servo gate which is obtained first thereafter, and write and read of check data is performed; thus, the rotation waiting caused by track switching synchronized with the index can be eliminated.

When a defective sector map is to be created for the defect detection data stored in the log region 64 of FIG. 9, the index address pointer saved for each track is searched, and the defect detection data is read from the position thereof; thus, log information can be always processed in the order of the data frames which are arranged in the order wherein the index is at the top position. For example, the first track of FIG. 9 is the defect detection data D1 to Dn read from the point immediately after the index; therefore, the searched index address pointer 65-1 indicates the defect detection data D1 at the top, and it is read in the order of the defect detection data D1 to Dn. Meanwhile, in the second track, the defect detection data D1 to Dn is read and successively stored from the position which is shifted from the index by the skew time caused by track switching, and the index address pointer 65-2 indicates that the defect detection data Dn-1 is the data which is read immediately after the index. Therefore, for the second track, when the defect detection data is read in the order of Dn-1, Dn, D1, . . . Dn-2 from the position of the searched index address pointer 65-2, it can be read as the defect detection data which is arranged in the order wherein the index is at the top position. Note that details of the log region of FIG. 9 will be elucidated in the later description. In FIGS. 8A to 8C, in order to simplify the description, the formatter is activated in synchronization with the index in the first track; however, in an actual apparatus, also in the first track, the formatter is activated in synchronization with the servo gate which is obtained first immediately after on-track.

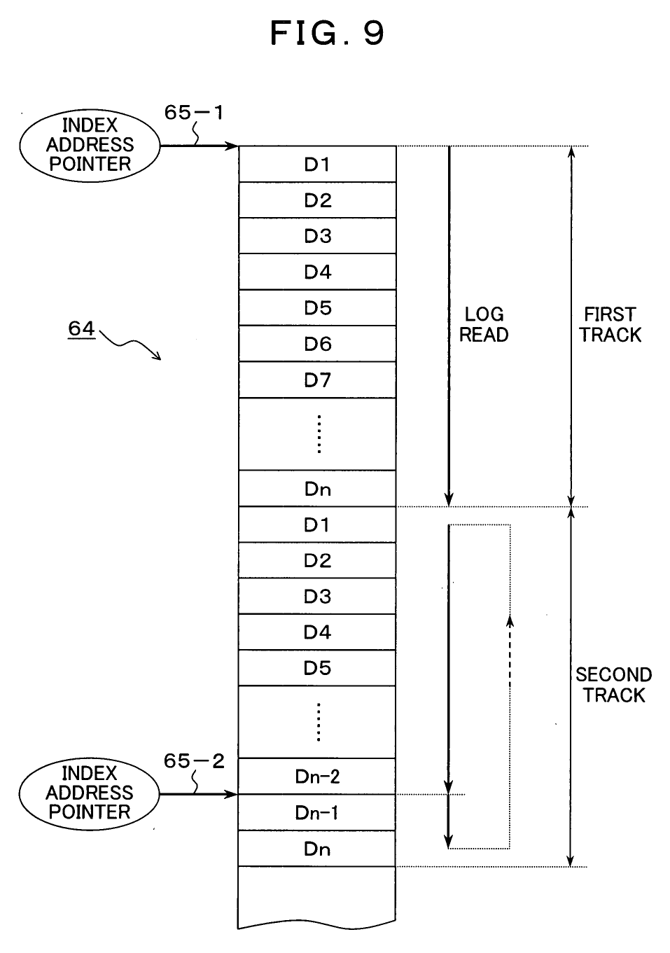

FIGS. 10A and 10B are time charts of the defect check process of the present invention according to the apparatus configuration of FIGS. 2A and 2B, and it is shown as interconnected operations of the processor 12, the formatter 40, the defect checker 44, and the servo control unit 18. In FIGS. 10A and 10B, when the defect check process of the medium is started in the processor 12, an address HHCC with respect to the magnetic disk medium is set in step S1, and the head is positioned to, for example, the outermost circumferential top track by a seek control step S301 of the servo control unit 18. Note that, the address HHCC is a combination of a head address HH and a cylinder address (track address) CC. Therefore, head select (medium surface select) and specification of a target track address is performed by the address HHCC. When on-track is completed by the seek control with respect to the address HHCC, the processor 12 checks generation of a servo gate signal in step S2; and, when a first servo gate signal is obtained after on-track, it proceeds to step S3, in which write of check data in data frame units is ordered. In response to this order, the formatter 40 is activated and writes the check data in the data frame units via read channel 16 in step S101 in synchronization with a sector pulse from the sector pulse generator 42 set at the same time which is generated immediately after the servo gate. Thus, write of the check data in the data frame units, in other words, write of the check data in which a data frame serves as one sector is repeated with respect to the track shown in FIG. 3 from the top data frame 58-1 toward the last data frame 58-n. In this state, the processor 12 checks write completion of the last data frame in step S4; and, when last data frame write completion is determined, it orders data read in data the data frame units in step S5. In response to this order of data read, the formatter 40 sets a read gate under the same sector pulse generation conditions, performs read from the magnetic disk medium in the data frame units, and transfers the defect detection data obtained via the read channel 16 to the defect checker 44 in step S102. The defect checker 44 creates defect log information by processing the defect detection data transferred via the formatter 40 in step S201, and, when it is, accumulated to a certain amount in the FIFO 38, it is registered as the defect log information 52 in the DRAM 20. Subsequently, the processor 12 checks read completion of the last data frame in step S6, when it is determined, recognizes completion of the defect detection process with respect to the track of the address set in step S1, increments the address CC to CC=CC+1 in step S7, and orders seek control of step S302 to the servo control unit 18; thus, the servo control unit 18 performs one-track seek in which the head is caused to seek an adjacent track from the current track. When an on-track state is attained by the one-track seek by the address setting of step S7, the processor 12 monitors generation of a servo gate signal in step S8, and, when the servo gate signal is determined, orders write of the check data in data frame units in step S9 as well as step S3; in response to this, the formatter 40 write the check data to the magnetic disk medium in the data frame units in step S103. Subsequently, in step S10, the processor 12 executes a creation process of defective sector position information, i.e., a defective sector map for the defect log information registered for the previous track. Subsequently, the processor 12 monitors write completion of the last data frame, and, when it is determined, orders read of the check data in the data frame units in step S12 as well as step S5; and the formatter 40 reads it from the magnetic disk medium in the data frame units and transfers the defect detection data obtained by the read channel 16 to the defect checker 44 in step S104; and, in step S202, the transferred defect detection data is processed to store log information in the FIFO 38, and, when it reaches a certain amount, it is registered as the defect log information 52 in the DRAM 20. Subsequently, in step S13, the processor 12 performs a process of creating a defective sector map as defective sector position information from the defect log information which is registered for the previous track. The creation process of the defective sector position information is a process subsequent to step S10. In other words, in the present invention, in parallel with creation and saving of the defect log information performed by writing and reading check data for a certain track, the defect log information the defect log information obtained in the previous process for the one previous track is analyzed, and a defective sector map in a predetermined sector length is created by parallel processing. Therefore, almost at the same time as creation of the defect log information performed by write and read of the check data for all the tracks of the disk medium surface, the creation process of the defective sector map for all the tracks performed by analysis is completed.

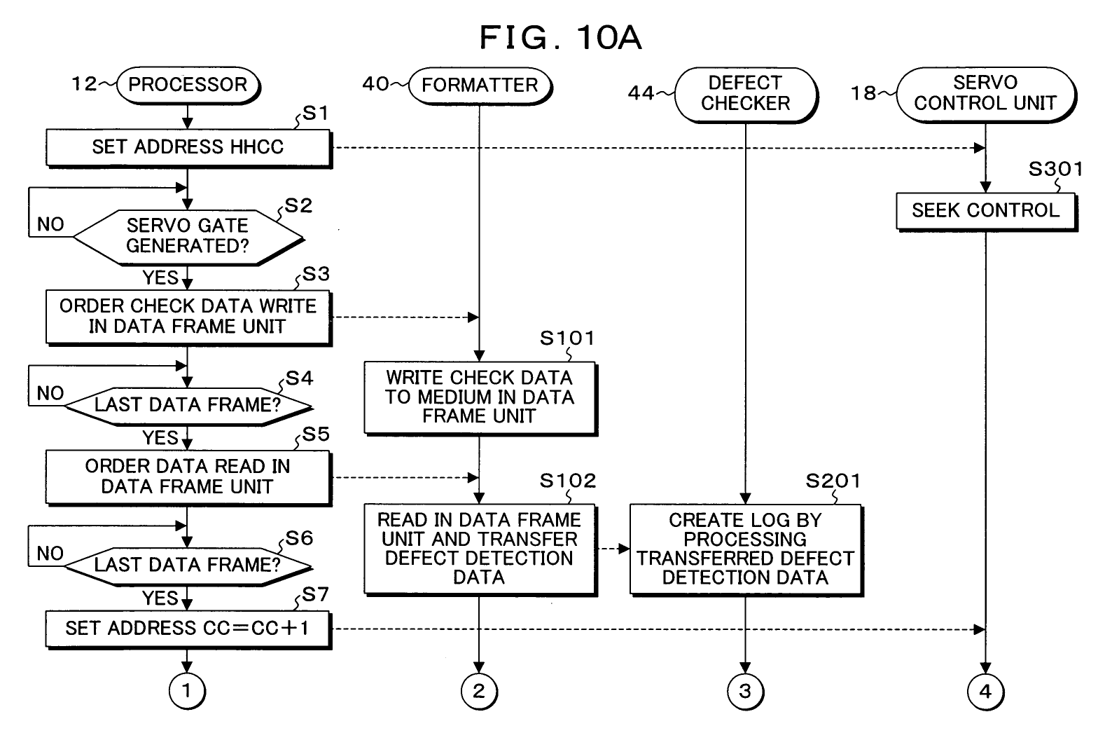

FIGS. 11A and 11B are flow charts of the defect check process by the processor 12 of FIGS. 2A and 2B. In FIGS. 11A and 11B, in the defect check process by the processor 12, after the address HHCC specifying the top track position of a certain head of the magnetic disk medium is set to perform head select in step S1, a seek control order is given in step S2 to position the head to the top track. Subsequently, when on-track response is determined in step S3, and generation of a servo gate signal is checked in step S4; and, when it is determined, a write order of the check data in data frame units is given in step S5 to start write of the check data. Subsequently, in step S6, a process of creating a defective sector map based on the log information of one previous track is executed. Note that, in the process of the top track, this process is skipped since the log information of one previous track is not present. Subsequently, when write completion of the last data frame is determined in step S7, read of the check data in the data frame units is ordered in step S8, and the defect detection data is caused to be output from the read channel 16 by performing read of the check data from the track to which write has been finished. Subsequently, in step S9, since the defect detection data is output from the read channel 16 and given to the defect checker 44 via the formatter 40, processing and registration of the log information is ordered with respect to the defect checker 44; consequently, processing such as a mask process of the defect detection data, extraction as log information, and rounding in which the defect detection data adjacent with a predetermined interval is combined into one is performed, log information is then created, and an index address pointer is retained with respect to the log information. Subsequently, in step S10, a creation process of a defective sector map based on the log information of one previous track is performed. This is a process subsequent to that of step S6; and, if the process is completed in step S6, the process of step S10 is not required. Subsequently, when read completion of the last data frame is determined in step S11, the defect check process corresponding to one track is therefore completed; thus, whether it is the last track or not is checked in step S12; and, if it is not the last track, after the track address, i.e., the cylinder address CC is incremented by one in step S13, the process returns to step S2, and similar processes are repeated for the next track. When it is the last track in step S12, whether it is the last head or not is checked in step S14; and, if it is not the last head, after the head address HH is incremented by one in step S15, the process returns to step S1, and head select and the head address HHCC is set for the next disk medium surface to repeat similar processes. When it is the last head in step S14, after a creation process of a defective sector map based on log information is performed for the last one track, the process is terminated. Note that, the defective sector maps created for each of the magnetic disk medium surfaces are stored in the system area of the medium surface.

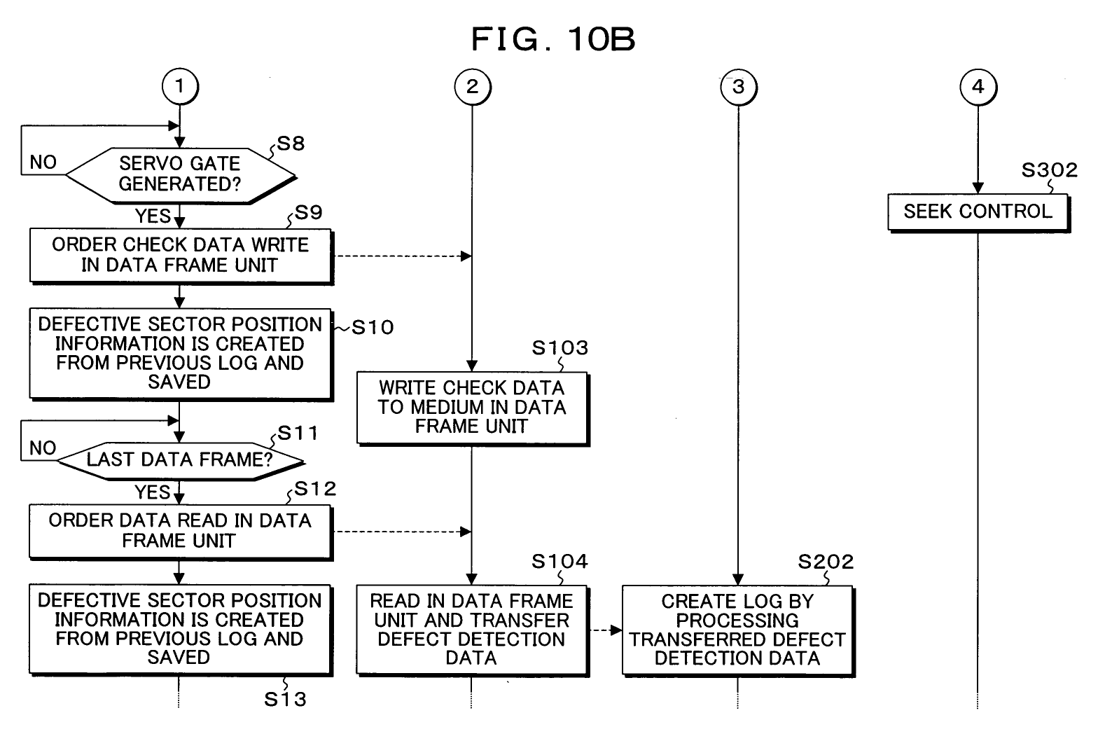

FIG. 12 is a format explanatory diagram of the defect log information reflected to the DRAM 20 of FIGS. 2A and 2B. In FIG. 12, the log region 64 having a predetermined size is reserved in a memory region 62 of the DRAM 20, and the top position of the registered log information 66 is expressed by the value of a log address pointer which is changed as shown by an arrow 56-1. More specifically, the initial value of the log address pointer is the top address, it is incremented as shown by the arrow 56-1 every time the registered log information 66 is stored in the log region 64, log registration is terminated when it reaches the end address as shown by an arrow 56-2, and, with respect to log registration more than that, an error is caused due to log over. In the log information registered in the log region 64, as the registered log information 66 extracted and shown in the right side, defect information of a frame start mark 68-1, a frame number 70-2, and entries 78-1, 78-2 . . . subsequent to that are registered for one track. The contents of the entry 78-1 is composed of three pieces of information,

(1) defect start position 72-1,

(2) defect length 74-1, and

(3) defect type 76-1.

A frame start mark 68-i, a frame number 70-i, and an entry 78-i subsequent to that are defect detection information in an arbitrary track i. As a matter of course, the format of the defect log information according to the present invention is not limited to the embodiment of FIG. 12, and a format style which stores arbitrary information can be used as long as the defect detection positions in a track starting from an index can be specified by the information based on the defect detection information obtained from a data channel. Moreover corresponding to the log region 64 of FIG. 12, the index address pointer shown in FIG. 9 specifying the frame number immediately after the index in the track unit is retained.

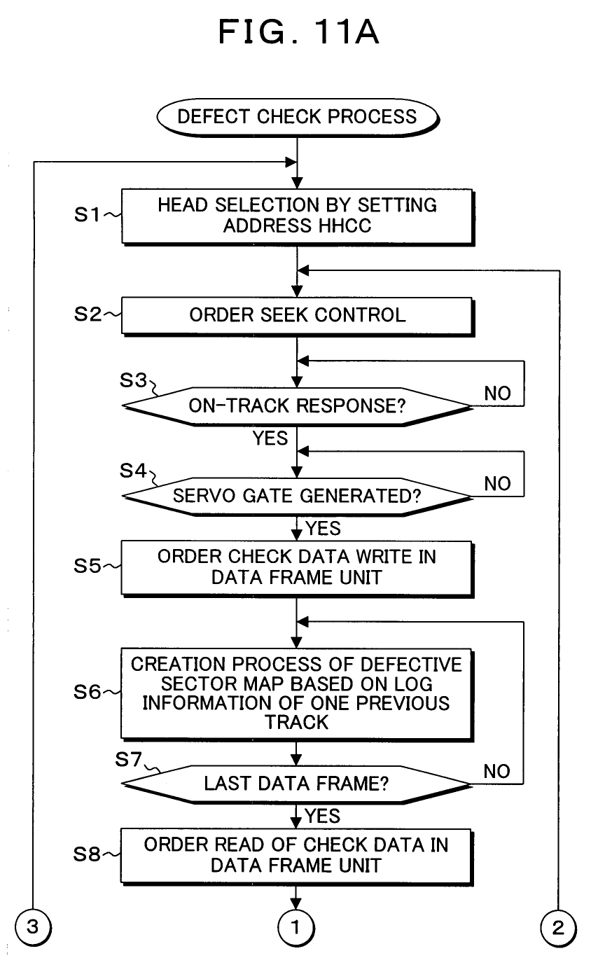

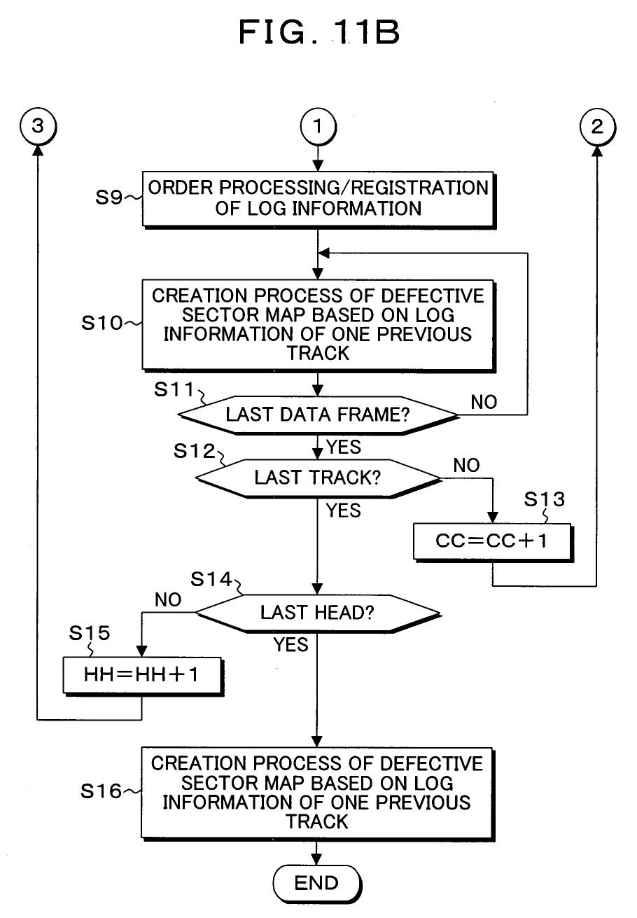

FIG. 13 is a flow chart of a log registration process by the defect checker 44 of FIGS. 2A and 2B. In the log registration process by the defect checker 44, since defect detection data 80 shown in FIG. 14A is subjected to processing, the mask data 82 of FIG. 14B, the log select value 84 of FIG. 14C, and the defect length extension count 85,of FIG. 14D are set in advance. The defect detection data of FIG. 14A is composed of hexadecimal data (h3 h2 h1), which is (b12 to b1) when expressed in binary; and, in this example, a small level of an analog read signal due to a defect is set in bit b6, a large level of an analog read signal due to a defect is set in a bit b7, and level shift of an analog read signal due to a defect is set in bit b8. The mask data 82 of FIG. 14B performs bit setting in which the defect detection data is eliminated from a log object by masking. In this example, the mask data 82 is (0100h) in hexadecimal and eliminates the defect detection data from a log object as a mask object for which bit 1 is set in a binary bit sequence shown in the right side. The log select value 84 of FIG. 14C is used for extracting the defect detection data which is to be registered as log information. The log select value 84 is, for example, (00C0h) in hexadecimal and selects and registers, as log data, the defect detection data for which bit 1 is set in the binary bit sequence shown in the right side. Herein, priorities are set among the mask data 82 and the log select value 84, and the priorities are set so that that of the mask data 82 is high. More specifically, when the bit of the mask data 82 is set and the bit of the select value 84 is also set for the defect detection data, the mask data 82 having the higher priority becomes effective, and it is eliminated from the log object. Therefore, the log select value 84 is applied to the defect detection data which is not an elimination object according to the mask data 82. When the interval of defect detection data output from the read channel 16 is, for example, equal to or less than 5 words according to the defect length extension count 85 of FIG. 14D, the process of rounding it into one defect detection data by extending and combining the defect detection data positioned at the top with the defect detection data positioned in the rear is executed.

The log registration process of FIG. 13 in which the mask data 82, the log select value 84, and the defect length extension count 85 of FIGS. 14B to 14D will be as the following. First of all, AND of the defect detection data and the mask data 82 is calculated in step S1, and whether it is “0” or not is checked in step S2. Since the bit of the mask data 82 is set in the defect detection data if it is not “0”, it is determined to be a mask object, and log registration is not performed. When it is “0” in step S2, it is not assumed as a mask object in step S3, and AND between the defect detection data and the log select value 84 is calculated in step S4. When the calculation result is not “0” in step S5, it proceeds to step S6 since the bits of the log select value 84 are set in the defect detection data, and the defect detection data is logged. Since the bits of the log select value 84 are not set when it is “0” in step S5, it is eliminated from the log object and logging is not performed in step S10. When it is assumed as a log object based on the log select value in step S6, whether the distance from the defect detection data previously served as a log object is equal to or less than 5 words, which is the set value of the defect length extension count 85, is checked. When it is equal to or less than 5 words, the preceding defect detection data is extended so as to combine them into one log and register it in step S8. The defect checker 44 further executes an event process with respect to particular defect detection data. The defect detection data to be subjected to the event process is, for example, abnormal data due to thermal asperity (TA). The defect checker 44 obtains an event count by counting abnormal detection data output from the read channel 16 due to generation of thermal asperity, and, when the event count exceeds a predetermined threshold value, abnormally terminates the defect check process with the status of event overflow.

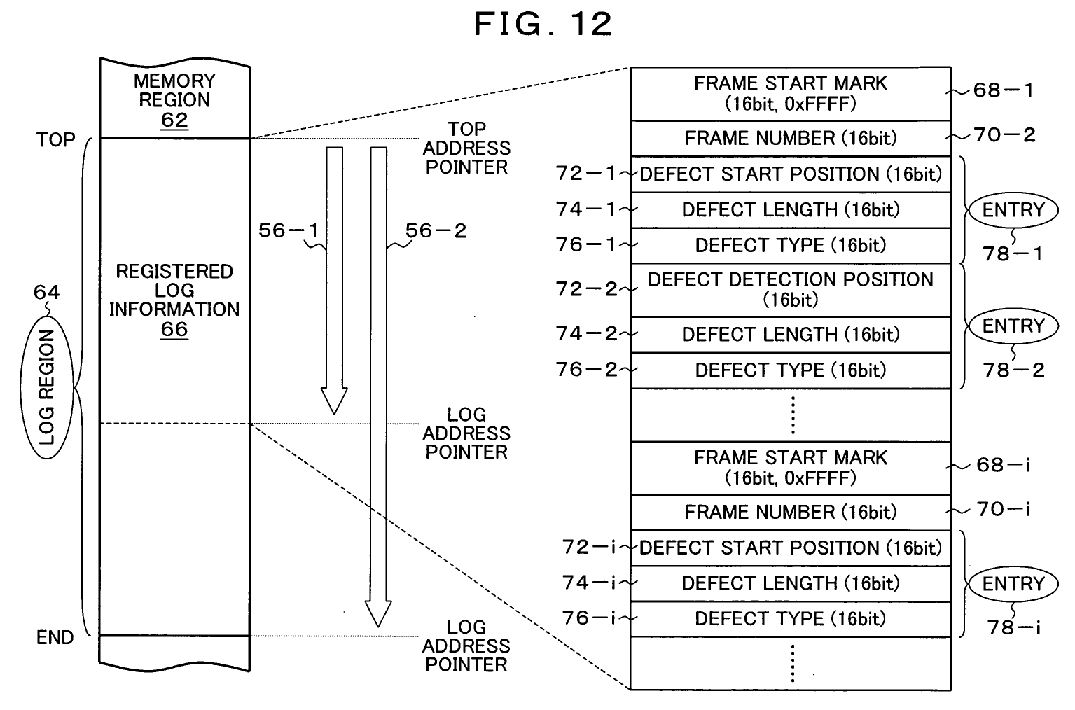

FIGS. 15A and 15B to FIGS. 21A and 21B are specific examples of processing processes of the defect detection data in the log registration process of FIG. 13. FIGS. 15A and 15B are explanatory diagrams of defect detection data subjected to log registration wherein bits of the mask data is not set and bits of the log select value are set and log data. FIG. 15A shows the defect detection data, in which defect detection data 86, 88, and 90 is successively obtained. In the number “1(080h)” shown below the defect detection data 86, the number “1” at the top is the word number of the defect detection data, and the following “(080h)” is hexadecimal defect detection data per se. The defect detection data 86 is followed by 5-word data having no defects, and the 2-word defect detection data 88 is subsequently generated, wherein the contents thereof is “2(060h)” in hexadecimal. Subsequently, with 6-word data having no defects interposed between, the defect detection data 90 is present, wherein it is 1 word, and the contents thereof are “1(080h)” in hexadecimal.

When AND with the mask data 82 shown n FIG. 14B is calculated for the defect detection data 86, 88, and 90 of FIG. 15A, all of them result in “0”; thus, they are eliminated from mask objects since bits of the mask data are not set. Subsequently, when AND with the log select value 84 of FIG. 14C is calculated, since bits of the log select value 84 are set in all of the defect detection data 86, 88, and 90, all of them are registered as log data. Furthermore, when counting is performed for the defect detection data 86, 88, and 90 wherein the value of the defect length extension length count 85 is L, L=5; and, since it is equal to or less than the 5 words set in FIG. 14D, the preceding defect detection data 86 is extended so as to round them into one log data 92 combined with the defect detection data 88. The log data 92, which has undergone the rounding process in the defect length extension process, has a word length of 8 words which is a sum of the 1 word of the defect detection data 86, 5 words of the data having no defects, and 2 words of the defect detection data 88. The contents of the log data is
(080h)+(060h)=(0E0h)
by adding the defect detection data 86 to the defect detection data 88. The defect detection data 90 serves as log data without change.

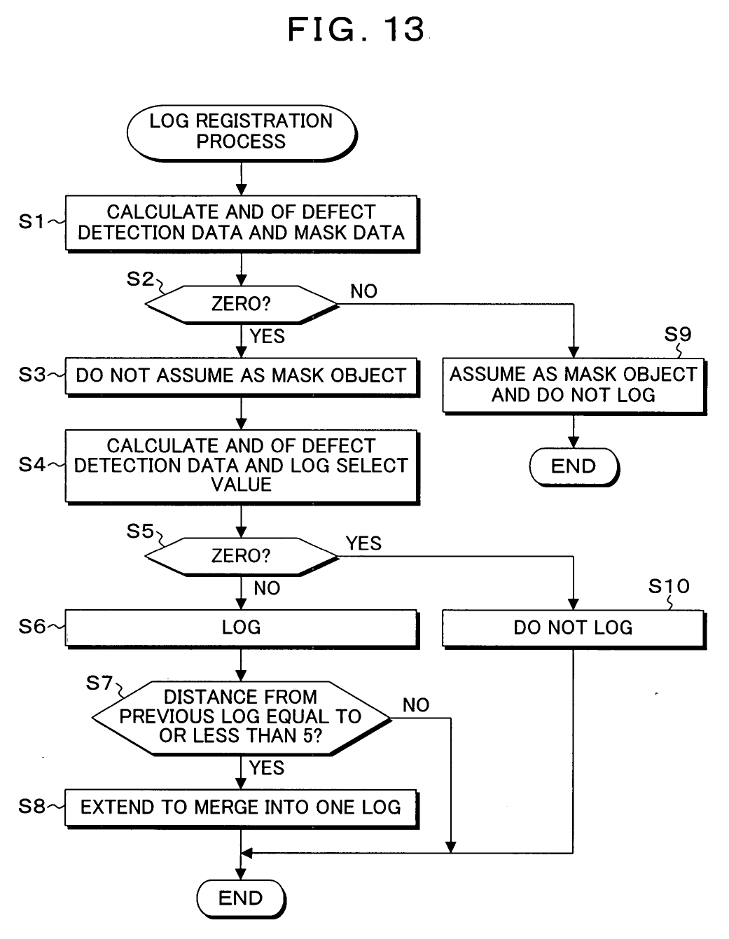

FIGS. 16A and 16B are explanatory diagrams of defect detection data eliminated from log registration according to the mask data and log data. Among defect detection data 94, 96, and 98 of FIG. 16A, when AND with the mask data 82 of FIG. 14B is obtained for (140h) of the defect detection data 96, the calculation result is not “0”, it is eliminated as a mask object, and the remaining defect detection data 94 and 98 serve as log data 94 and 98 without change.

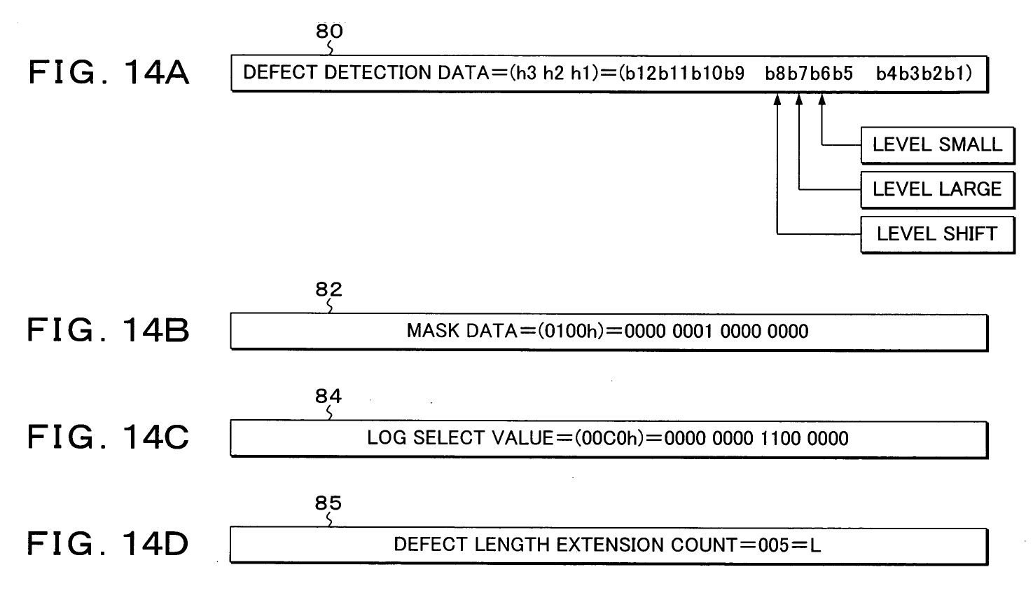

FIGS. 17A and 17B are explanatory diagrams of defect detection data, which is eliminated from log registration since the log select value 84 is not set, and log data. When AND with the mask data 82 of FIG. 14B is respectively calculated for all of defect detection data 100, 102, and 104 of FIG. 17A, the calculation results are “0”; thus, all of them are not eliminated as mask objects.

Next, when AND with the log select value 84 of FIG. 14C is calculated, the calculation result of the defect detection data 102 is “0”, the defect detection data 102 is eliminated from log objects since the bits of the log select value are not set, and merely the defect detection data 100 and 104 serve as log data 100 and 104 without change.

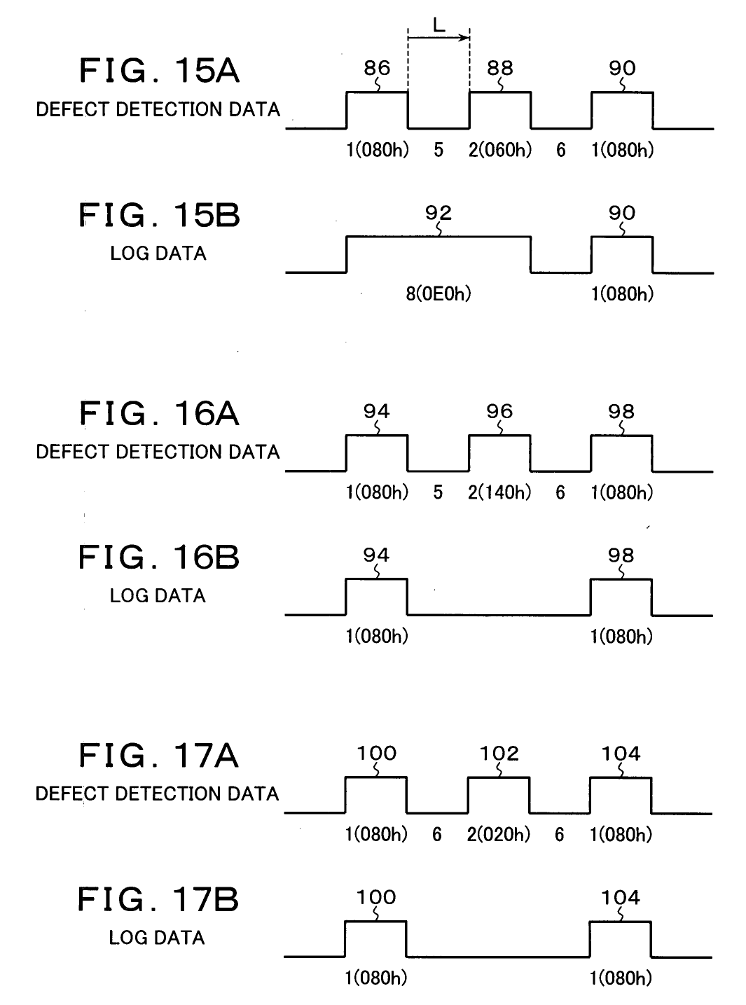

FIGS. 18A and 18B are explanatory diagrams of defect detection data, to be rounded by extending continuous defect detection data, and log data. In FIG. 18A, defect detection data 106 and 108 is continuous, and, with an interval of 10 words having no defects, defect detection data 110 and 112 are continuous. The defect detection data 106 and 108 is selected as log objects, since bits of the mask data are not set and bits of the log select value are set; it serve as log data 114 through rounding in which the data is combined into one since the defect length extension count L is L=0; and the contents thereof are 2 words and have the value of
(080h)+(040h)=(0C0h).

Since the bits of the mask data are not set and the bits of the log select value are set in the defect detection data 110, it serves as log data 110; however, the defect detection data 112 is eliminated from log objects since the bits of the log select value are not set therefor.

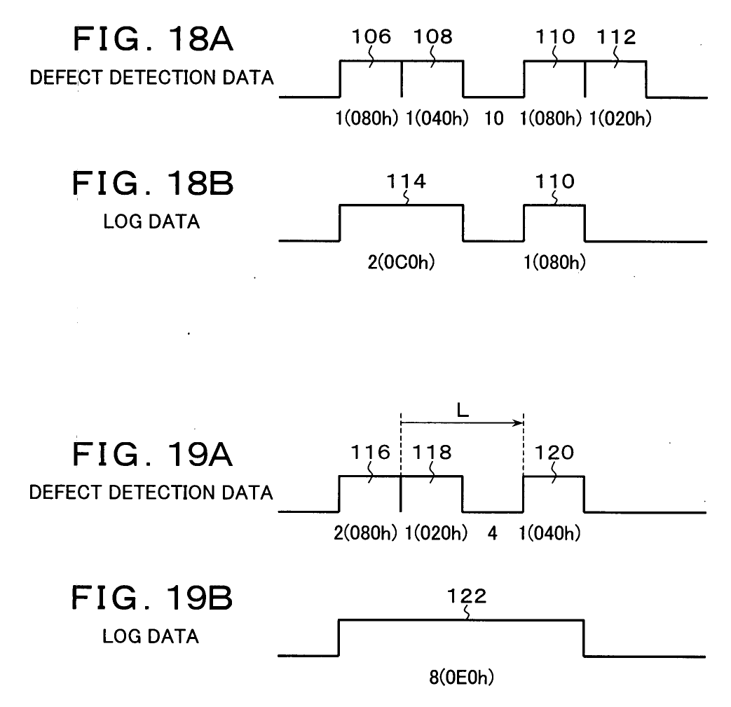

FIGS. 19A and 19B are explanatory diagrams of defect detection data pieces, which are adjacent to each other within the defect length extension count of 5 words or less serving as a threshold value, and log data. All of defect detection data 116, 118, and 120 of FIG. 19A do not serve as mask objects but serve as log objects since the bits of the log select value are set. Furthermore, since the defect length extension count L from the defect detection data 116 to the defect detection data 120 is
L=1+4=5 words,
which is equal to or less than the threshold value, the defect detection data 118 is extended, and it is registered as log data 122 which is the three pieces of defect detection data 116, 118, and 120 rounded into one. The log data 122 has a word length of
2+1+4=8 words, and
the contents thereof are
(080h)+(020h)+(040h)=(0E0h).

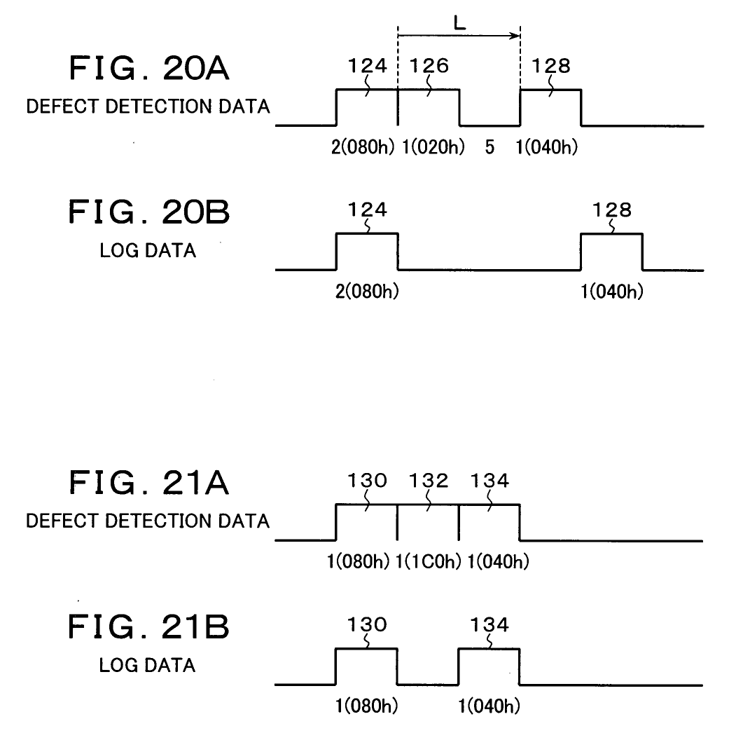

FIGS. 20A and 20B are explanatory diagrams of defect detection data pieces, which are adjacent to each other over the threshold value of the defect extension count, and log data. Defect detection data 124, 126, and 128 of FIG. 20A has the defect length extension count L of
L=1+5=6 words,
which exceeds the threshold value; therefore, rounding into one defect detection data is not performed. Furthermore, the defect detection data 126 is eliminated from log objects since the bits of the log select value are not set, and two pieces of them, the defect detection data 124 and 128 serve as log data.

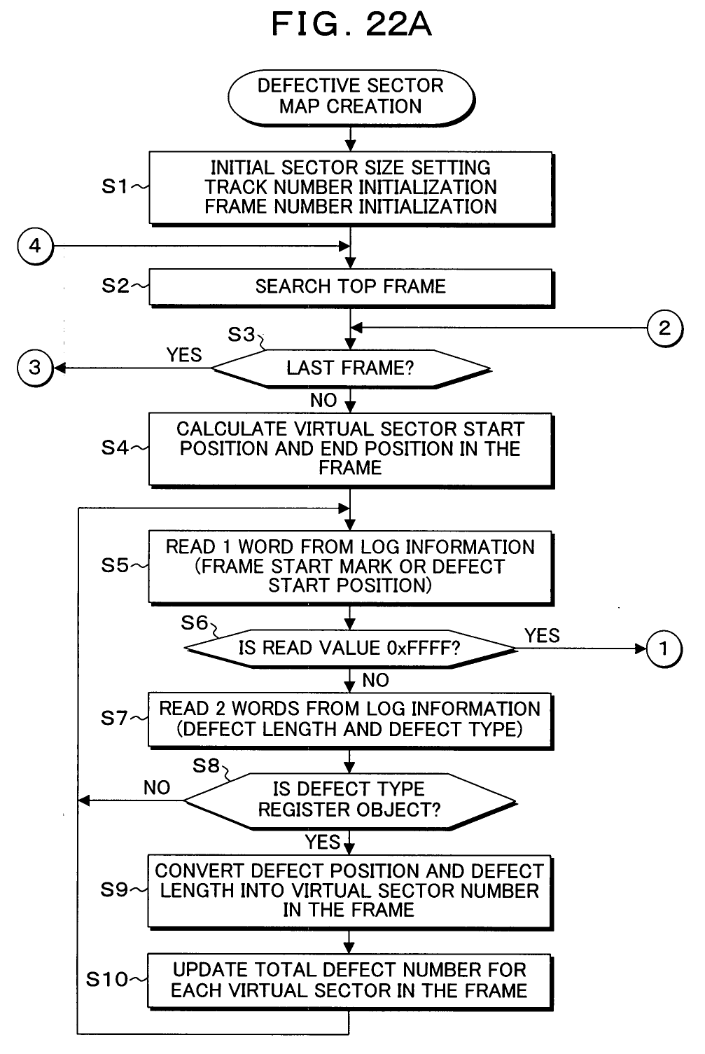

FIGS. 21A and 21B are explanatory diagrams of log registration in the case in which defect detection data having the bits of the mask data is present in continuous defect detection data. Among defect detection data 130, 132, and 134 of FIG. 21A, the bits of the mask data 82 of FIG. 12B are set in the center defect detection data 132. The defect detection data 132 is eliminated as a mask object from log objects; as a result, two pieces of them, the defect detection data 130 and 134 serve as the log data shown in FIG. 21B.

Note that, in the log data shown in FIGS. 15A and 15B to FIGS. 21A and 21B, the word numbers of the part corresponding to the data having no defects are not shown, this means that merely the defect detection data processed as the log data is registered as the log information.

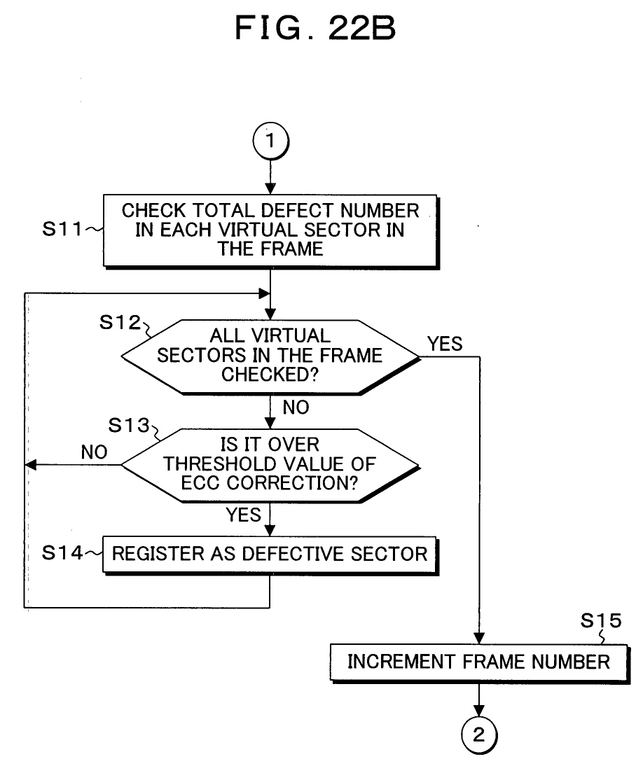

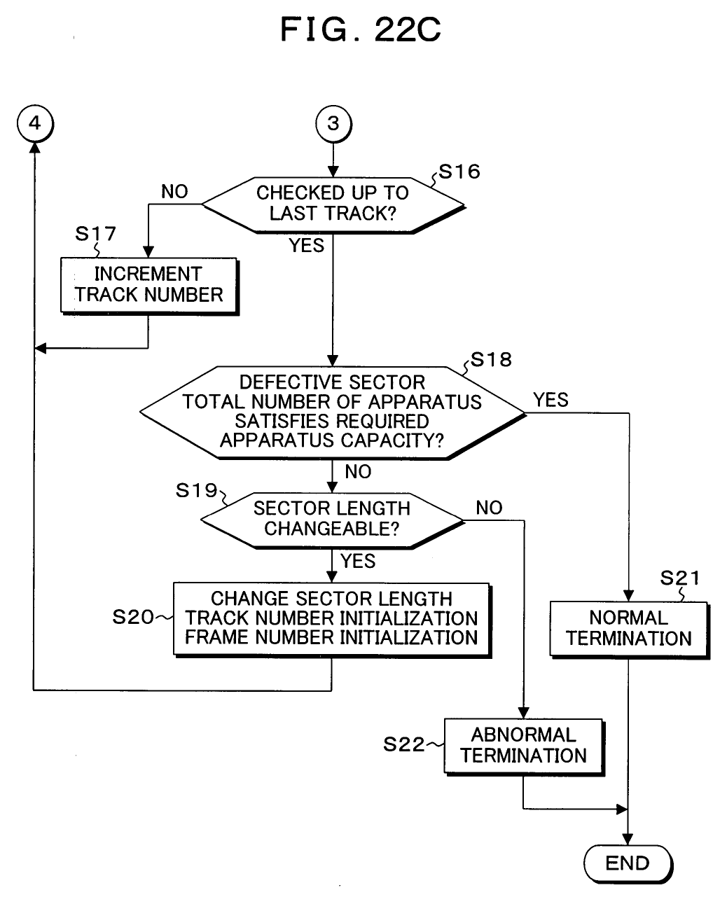

FIGS. 22A to 22C are flow charts of a defective sector map creation process by the processor 12 of FIGS. 2A and 2B. In FIGS. 22A and 22B, the defective sector map creation process is executed in the state in which the registered log information 66 is stored in the log region 64 as shown in FIG. 12. In FIGS. 22A and 22B, in the defective sector map creation process, in step S1, initial sector size setting, track number initialization, and frame number initialization are performed. As the initial sector size, for example, when 512 bytes and 520 bytes are supported as sector lengths, for example, the sector size of 512 is set as an initial value. Subsequently, the top frame is searched for the registered log information in step S2, and, via the bits of the last frame in step S3, a start position and an end position of virtual sectors in a frame are calculated in step S4. Subsequently, in step S5, a first one word is read from the log information. The first one word is either the frame start mark 68-1 or the defect start position 72-1. Herein, the defect start position 72-1 is the position indicated by the index address pointer which is saved upon log creation. Subsequently, in step S6, whether the read position is “0xFFFF” indicating a frame start mark or not is checked. When it is not the frame start position, the value read in step S5 is, for example, the defect start position 72-1 at the top of the entry 78-1 of FIG. 12; therefore, it proceeds to step S7, in which next two words are read from the log information.

The two words are the defect length 74-1 and the defect type 76-1 of the entry 78-1 in FIG. 12. Subsequently, whether the defect type is a registration object or not is checked in step S8; and, when it is a registration object, it proceeds to step S9, in which the defect position and the defect length are converted into virtual sector numbers in the frame. Subsequently, in step S10, the total number of defects is updated for each virtual sector in the frame. Subsequently, it returns to step S5, in which one word is read from the log information, and the processes of step S6 to S10 are repeated. When the process of one frame is finished, the frame start mark at the top of the next frame is determined in step S6; therefore, in this case, it proceeds to step S11, in which the total number of defects for each virtual sector in the frame is checked, and whether the checked total number of defects in each sector exceeds the threshold value of ECC correction or not is checked in step S13 until all the virtual sectors in the frame are checked in step S12; and, when it exceeds that, it is registered as a defective sector in step S14. The processes of steps S11 to S14 are repeated until check of all the virtual sectors in the frame is finished; and, when the check is finished, it proceeds to step S15, in which the frame number is incremented, whether it is the last frame or not is then checked in step S3, and the processes of steps S4 to S14 are repeated for the next frame if it is not the last frame. When it is determined to be the last frame in step S3, the process proceeds to step S16 of FIG. 22C, in which whether check is performed up to the last track or not is determined; and, if it is not the last track, the track number is incremented in step S17, the process returns to step S2, and the creation process of the defective sector map is repeated for the next track. When check completion of the last track is determined in step S16 of FIG. 22C, the process proceeds to step S18, in which whether the total defective sector number of the apparatus satisfies a required apparatus capacity or not, in other words, whether the allowable total number of defective sectors of the apparatus is satisfied or, not is checked; and, if it is satisfied, the process proceeds to step S21, and the defective sector map creation process is terminated as normal termination. When the total number of defective sectors does not satisfies the required apparatus capacity in step S18, the process proceeds to step S19, in which whether the sector length can be changed or not is checked. When the sector length can be changed to, for example, 520 bytes which is the other sector length with respect to the 512 bytes which is the initial sector size in step S1, the process proceeds to step S20, in which initialization of the track number and initialization of the frame number is performed after the sector length is changed; and then, the process returns to step S20 of FIG. 22C, and the creation process of the defective sector map is repeated for the same log information wherein the sector length after the change serves as the virtual sector. When the sector length cannot be changed in step S19, abnormal termination is performed in step S22.

In the creation process of the defective sector map shown in FIGS. 22A to 22C, as shown in the time chart of FIGS. 10A and 10B and the flow chart of FIGS. 11A and 11B of the processor, the creation process of the defective sector map is performed for the log information which is obtained for the one previous track in parallel with the write/read process of the check data with respect to a certain track. Therefore, the defective sector map creation process can be completed at the point of time which is obtained by further adding the processing time corresponding to one track to the time until completion of registration of the log information based on write/read of the check data with respect to all the tracks of the magnetic disk surface, and, in practice, the creation process of the defective sector map can be completed at the same time as the completion of the write/read process of the check data.

Note that, in the defective sector map creation process of FIGS. 22A to 22C, a particular sector size among a plurality of sector sizes is initially set to create the defective sector map; however, without setting the sector size, a defective sector map indicating byte distances from the index to defect positions may be created and saved in a medium system area, and, then, a sector size may be set so as to create a defective sector map corresponding to the sectors.

Furthermore, the present invention provides programs for the defect check process executed by the processor 12 provided in the magnetic disk control apparatus of FIGS. 2A and 2B, and these programs respectively have the processing contents of the flow chart of FIGS. 11A and 11B and the flow chart of FIGS. 22A to 22C.

Note that the present invention includes arbitrary modifications that do not impair the object and advantages thereof and is not limited by the numerical values shown in the above described embodiments. Furthermore, the above described embodiments take the magnetic disk apparatus, which is known as a hard disk drive, as an example; however, the present invention can be applied without modification to an arbitrary storage apparatus which requires defect check of media.

1. A storage apparatus characterized by having a check data write/read unit which writes and reads check data of a defect in a data frame unit between servo frames recorded on a medium;
a log creation unit which creates log information from defect detection data generated by reading the check data in the data frame unit and saves the log information; and
a defective sector information creation unit which creates defective sector information indicting the position of a defective sector in a predetermined sector length through analysis of the log information and saves the defective sector information.

2. The storage apparatus according to characterized in that, in parallel with a write/read process of one track performed by the check data write/read unit, the defective sector information creation unit executes a process of creating the defective sector information from the log information created by the process of one previous track.

3. The storage apparatus according to claim 1, characterized in that the check data write/read unit has a read channel circuit; the read channel circuit can select and set a first mode in which the check data which is demodulated by subjecting an analog read signal of a head to digital conversion is output, and a second mode in which defect detection data in which analog variation including a level and shift due to a defect of the analog read signal is determined is output; and the second mode is selected and set so as to output the defect detection data.

4. The storage apparatus according to claim 1, characterized in that
the check data write/read unit sequentially orders start of write of the check data corresponding to one track at every timing when a first servo gate signal is obtained after on-track to a processing object track is performed, start of read of the check data corresponding to one track, and switch to a next track;
the log creation unit creates the log information from the defect detection data read from the track, saves the log information, and saves an index address pointer indicating a log position immediately after an index; and
the defective sector information creation unit reads the log information from the log position indicated by the index address pointer and processes the log information.

5. The storage apparatus according to claim 1, characterized in that the log creation unit processes the defect detection data which is output through the medium reading in the data frame unit, and then saves the defect detection data as the log information.

6. The storage apparatus according to claim 5, characterized in that the log creation unit compares the defect detection data with mask data which is set in advance and, when the defect detection data is determined as a mask object, eliminates the defect detection data from a log object.

7. The storage apparatus according to claim 5, characterized in that the log creation unit compares the defect detection data with the mask data which is set in advance; and, when the defect detection data is determined as a non-mask object, compares the defect detection data with a defect select value which is determined in advance, and saves the defect detection data as log information when the data includes the defect select value.

8. The storage apparatus according to claim 5, characterized in that, when an emerging interval of the defect detection data is equal to or less than a threshold value which is set in advance, the log creation unit extends preceding medium detection data and combines the preceding data with the succeeding medium detection data so as to convert the data into one defect detection data.

9. The storage apparatus according to claim 1, characterized in that the log creation unit stores, as the log information, defect information which is determined for each of the data frame from the defect detection data subsequent to a frame start position.

10. The storage apparatus according to claim 9, characterized in that the log creation unit stores, as the defect information, a defect start position, a defect length, and a defect type.

11. The storage apparatus according to claim 1, characterized in that the defective sector information creation unit converts one or plural pieces of defect information included in the log information into a sector number, and, when the total number of a defect in the same sector exceeds ECC correction ability, registers the number in the defective sector information as a defective sector.

12. The storage apparatus according to claim 1, characterized in that the defective sector information creation unit creates the defective sector information from the log information for a plurality of different sector lengths in accordance with needs.

13. The storage apparatus according to claim 1, characterized in that when the total number of defective sectors exceeds a predetermined allowable value according to the defective sector information of the predetermined sector length, the defective sector information creation unit changes the sector length to another predetermined sector length and creates defective sector information again from the log information.

14. A defect check method of a storage apparatus characterized by including
a check data write/read process in which check data of a defect is written and read in a data frame unit between servo frames recorded on a medium;
a log creation process in which log information is created from defect detection data generated by reading the check data in the data frame unit and saved; and
a defective sector information creation process in which defective sector information indicting the position of a defective sector in a predetermined sector length is created through analysis of the log information and saved.

15. The defect check method of the storage apparatus according to claim 14, characterized in that, in parallel with a write/read process of one track performed by the check data write/read step, the defective sector information creation step executes a process of creating the defective sector information from the log information created by the process of one previous track.

16. The defect check method of the storage apparatus according to claim 14, characterized in that, in the check data write/read process, with respect to a reach channel circuit which can select and set a first mode in which the check data which is demodulated by subjecting an analog read signal of a head to digital conversion is output, and a second mode in which defect detection data in which analog variation including a level and shift due to a defect of the analog read signal is determined is output, the second mode is selected and set so as to output the defect detection data.

17. The defect check method of the storage apparatus according to claim 14, characterized in that
in the check data write/read process, start of write of the check data corresponding to one track at every timing when a first servo gate signal is obtained after on-track to a processing object track is performed, start of read of the check data corresponding to one track, and switch to a next track are sequentially ordered;
in the log creation process, the log information is created from the defect detection data read from the track and saved, and an index address pointer indicating a log position immediately after an index is saved; and
in the defective sector information creation process, the log information is read from the log position indicated by the index address pointer and processed.

18. The defect check method of the storage apparatus according to claim 14, characterized in that, in the log creation process, the defect detection data which is output through the medium reading in the data frame unit is processed and then saved as the log information.

19. A computer-readable storage medium which stores a program characterized by causing a computer of a storage apparatus to execute
a check data write/read process in which check data of a defect is written and read in a data frame unit between servo frames recorded on a medium;
a log creation process in which log information is created from defect detection data generated by reading the check data in the data frame unit and saved; and
a defective sector information creation process in which defective sector information indicting the position of a defective sector in a predetermined sector length is created through analysis of the log information and saved.

20. The storage medium according to claim 19, characterized in that, in parallel with a write/read process of one track performed by the check data write/read step, the defective sector information creation process executes a process of creating the defective sector information from the log information created by the process of one previous track.
